(19) United States
(12) Patent Application Publication
(10) Pub. No.: US 2026/0030809 A1
(43) Pub. Date: Jan. 29, 2026

(54) IMAGE PROCESSING METHOD AND APPARATUS, STORAGE MEDIUM, AND ELECTRONIC DEVICE

(71) Applicant: Beijing Zitiao Network Technology Co., Ltd., Haidian District, Beijing (CN)

(72) Inventor: Peng Zhang, Beijing (CN)

(21) Appl. No.: 18/871,000

(22) PCT Filed: May 31, 2023
(86) PCT No.: PCT/CN2023/097319

§ 371 Date: Dec. 2, 2024

(30) Foreign Application Priority Data
Jun. 2, 2022 (CN) 202210625667.5

(51) Int. Cl. G06T 11/60

(52) U.S. Cl. CPC G06T 11/60

(57) ABSTRACT

The present disclosure provides an image processing method and apparatus, a storage medium, and an electronic device. The image processing method includes: receiving an image to be processed and a mask image of a target region in the image to be processed; processing the image to be processed and the mask image based on a stylization processing system, to obtain a stylized image associated with the target region; and displaying the stylized image associated with the target region.

The present application claims priority to Chinese Patent Application No. 202210625667.5, filed with the China National Intellectual Property Administration on Jun. 2, 2022, which is incorporated herein by reference in its entirety.

### FIELD

The present disclosure relates to image processing technologies, and for example, to an image processing method and apparatus, a storage medium, and an electronic device.

### BACKGROUND

With the continuous development of science and technology, more and more application software has come into life of users and gradually enriched sparetime life of the users. For example, the users can record their life in the form of videos, images, etc. by using a wide variety of application software, and upload the videos or images to a network.

Application software is used to perform stylization processing on the acquired videos or images, etc. However, there is a great difference and a poor association between stylized images obtained through stylization processing and original content before processing, which makes it impossible for the stylized images obtained through processing to reflect the content of original images well. For example, a stylized image, which is obtained by performing stylization processing on a portrait image, has a key region, such as a face, that is quite different from that in the original portrait image. As a result, the two images cannot be recognized to be of the same portrait.

### SUMMARY

The present disclosure provides an image processing method and apparatus, a storage medium, and an electronic device, to enhance an association between content of a stylized image and that of an original image.

An embodiment of the present disclosure provides an image processing method. The method includes:
receiving an image to be processed and a mask image of a target region in the image to be processed;
processing the image to be processed and the mask image based on a stylization processing system, to obtain a stylized image associated with the target region; and
displaying the stylized image associated with the target region.

An embodiment of the present disclosure further provides an image processing apparatus. The apparatus includes:
an image receiving module configured to receive an image to be processed and a mask image of a target region in the image to be processed;
an image processing module configured to process the image to be processed and the mask image based on a stylization processing system, to obtain a stylized image associated with the target region; and
an image display module configured to display the stylized image associated with the target region.

An embodiment of the present disclosure further provides an electronic device. The electronic device includes:
one or more processors; and
a storage apparatus configured to store one or more programs, where
the one or more programs, when executed by the one or more processors, cause the one or more processors to implement the image processing method provided in any embodiment of the present disclosure.

An embodiment of the present disclosure further provides a storage medium including computer-executable instructions, where the computer-executable instructions, when executed by a computer processor, are used to perform the image processing method provided in any embodiment of the present disclosure.

### BRIEF DESCRIPTION OF THE DRAWINGS

FIG. 1 is a schematic flowchart of an image processing method according to an embodiment of the present disclosure;

FIG. 2 is a schematic diagram of a structure of a stylization processing system according to an embodiment of the present disclosure;

FIG. 3 is a schematic diagram of a training process of an image reconstruction model according to an embodiment of the present disclosure;

FIG. 4 is a schematic diagram of a training process of an encoding model according to an embodiment of the present disclosure;

FIG. 5 is a schematic diagram of a training process of an image stylization model according to an embodiment of the present disclosure;

FIG. 6 is a schematic flowchart of an image processing method according to an embodiment of the present disclosure;

FIG. 7 is a schematic flowchart of an image processing method according to an embodiment of the present disclosure;

FIG. 8 is a schematic diagram showing a comparison between an image to be processed and a stylized image according to an embodiment of the present disclosure;

FIG. 9 is a schematic diagram of a structure of an image processing apparatus according to an embodiment of the present disclosure; and

FIG. 10 is a schematic diagram of a structure of an electronic device according to an embodiment of the present disclosure.

### DETAILED DESCRIPTION OF EMBODIMENTS

The embodiments of the present disclosure are described below with reference to the accompanying drawings. Although some embodiments of the present disclosure are shown in the accompanying drawings, the present disclosure may be implemented in various forms and should not be construed as being limited to the embodiments set forth herein. Rather, these embodiments are provided for understanding the present disclosure. The accompanying drawings and the embodiments of the present disclosure are only for exemplary purposes, and are not intended to limit the scope of protection of the present disclosure.

The plurality of steps described in method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

Concepts such as “first” and “second” mentioned in the present disclosure are only used to distinguish between different apparatuses, modules, or units, and are not used to limit the sequence or interdependence of functions performed by these apparatuses, modules, or units.

The modifiers “a/an” and “a plurality of” mentioned in the present disclosure are illustrative and not restrictive, and unless the context indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Before the use of the technical solutions disclosed in a plurality of embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from a user, prompt information is sent to the user to clearly inform the user that the requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

The above process of notifying and obtaining user authorization is only illustrative and does not constitute a limitation on the implementations of the present disclosure, and other manners that satisfy the relevant laws and regulations may also be applied in the implementations of the present disclosure.

The data involved in the technical solutions (including the data itself and the access to or use of the data) shall comply with the requirements of corresponding laws, regulations, and relevant provisions.

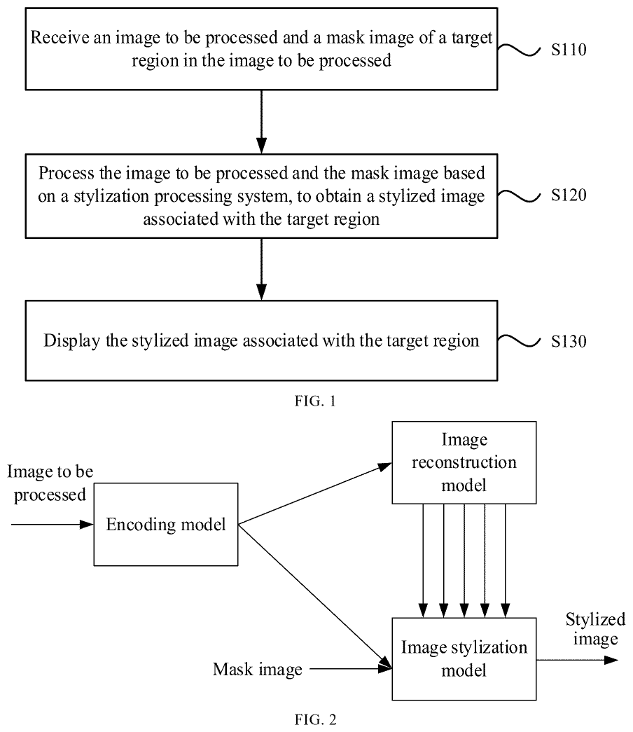

FIG. 1 is a schematic flowchart of an image processing method according to an embodiment of the present disclosure. This embodiment of the present disclosure is applicable to a case where an image to be processed is converted into a stylized image, and the method can be performed by an image processing apparatus according to an embodiment of the present disclosure. The image processing apparatus may be implemented in the form of software and/or hardware. Optionally, the image processing apparatus may be implemented by an electronic device, and the electronic device may be a mobile terminal, a personal computer (PC), a server, etc. As shown in FIG. 1, the method includes the following steps.
S110: Receive an image to be processed and a mask image of a target region in the image to be processed.
S120: Process the image to be processed and the mask image based on a stylization processing system, to obtain a stylized image associated with the target region.
S130: Display the stylized image associated with the target region.

The image to be processed is an original image to be subjected to stylization processing. In some embodiments, the image to be processed may be a single image, or may be a plurality of frames of images in a video to be processed, and correspondingly, the processing method of the present disclosure is performed on each frame of image in the video to be processed, to obtain a plurality of frames of stylized images that can form a stylized video.

The image to be processed may be imported from an external device, may be acquired by an externally connected image acquisition device (e.g. a camera), may be imported from a local storage (e.g. a local album), or may be acquired in real time by an image acquisition device (e.g. a built-in camera on the device). Correspondingly, application scenarios of the embodiment of the present disclosure include a stylization processing scenario for an input single image (which is acquired in real time, or acquired historically), a stylization processing scenario for an acquired video, and a stylization processing scenario for a video acquired in real time (e.g., a live streaming video).

The mask image of the target region in the image to be processed is an image that distinguishes, by using a mask, the target region from other regions in the image to be processed. The target region is a region in which the content remains strongly correlated with the original content during the stylization processing. There may be one or more target regions, which is determined according to the requirements of an operating user. The mask image may be in the form of an image or a data matrix, which is not limited.

In some embodiments, the target region may be manually selected by the operating user. For example, after the image to be processed is received, the image to be processed is displayed on a display screen of the device, and in a region selection mode, when a region selection operation performed by the user is detected, a target region corresponding to the region selection operation is determined. The region selection mode may be entered automatically after the image to be processed is displayed, or a region select control is provided on a display page such that the region selection mode is entered when the region select control is triggered.

The region selection operation may be a region contour drawing operation, in which a contour of the target region is drawn, by using a finger, a mouse, etc., in the image to be processed, and the region within the input contour is determined as the target region by recognizing the contour. Alternatively, the region selection operation may be determining the target region by setting a position and a size of a region selection box, where region selection boxes, such as a rectangular box and a circular box, may be displayed on the display page of the image to be processed. If a region selection box of any shape is selected, when a click operation in a display region of the image to be processed is detected, the position of the selection box may be determined; when a drag operation on the selection box is detected, the position of the selection box is adjusted based on the drag operation; and when a slide operation in the display region of the image to be processed is detected, the size of the selection box may be adjusted based on the slide operation. Based on the position and the size of the selection box, the region within the selection box is determined as the target region.

In some embodiments, the target region may be obtained through automatic recognition and automatic segmentation. Optionally, a region type is provided on the display page of the image to be processed. For example, the region type may include a face, an eye, a mouth, a portrait, food, a flower, a tree, foreground, background, etc., and the region type of the target region may be determined based on the selection of the user. Based on the selected region type, recognition is performed on the image to be processed, and based on a recognition result, image segmentation is performed on the image to be processed, to obtain the target region. For example, if the selected type is the face, recognition and segmentation are performed on the image to be processed, to obtain a facial region, and the facial region is then used as the target region. There may be a plurality of regions obtained through recognition. A selection may be made from the plurality of target regions obtained through recognition. For example, two facial regions are obtained through recognition from the image to be processed, where the selected facial region may be used as the target region, and the unselected facial region may be used as a non-target region.

Various region recognition models may be preset, including, for example, a face recognition model, a portrait recognition model, a food recognition model, etc. A corresponding region recognition model is called based on the region type, and the image to be processed is processed based on the called region recognition model, to output a segmented image of the target region.

A default type may be preset for the target region. For example, if the target region is a facial region, correspondingly, after the image to be processed is received, the facial region in the image to be processed is recognized and then used as the target region. The default type may be set and edited according to the requirements of the user.

Based on the target region, masking is performed on the image to be processed, where the target region and the non-target region may be distinguished by 0 and 1.

In this embodiment, the image to be processed and the mask image are processed by a pre-trained stylization processing system, to obtain the stylized image corresponding to the image to be processed, where a target region in the stylized image is associated with the target region in the image to be processed, that is, the target region in the stylized image is highly similar to the target region in the image to be processed. Therefore, a high level of authenticity and consistency of the target regions are maintained while stylization processing is performed. During processing of the image to be processed, the stylization processing system uses the mask image as auxiliary information, and incorporates the original content into processing process information of the target region, thereby maintaining a high level of consistency between the target region in the stylized image and the target region in the image to be processed.

A changed image style obtained by the stylization processing system by performing stylization processing on an image is not limited herein, and may be determined according to style change requirements. For example, the changed style corresponding to the stylization processing system may include an ancient style, an impressionist style, a sketch style, etc. Stylization processing systems corresponding to different style types may be obtained through training on images of corresponding style types, which is not limited. The structure of the stylization processing system is not limited herein. In some embodiments, the stylization processing system may be a machine learning model, such as a neural network model or a deep neural network model. In some embodiments, the stylization processing system may be formed by a plurality of machine learning models, and the plurality of machine learning models that form the machine learning model may be models of a same type, or models of different types.

The stylized image obtained based on the stylization processing system is displayed. For example, the image to be processed and the stylized image may be displayed on a same display page, thereby facilitating a comparison between the image to be processed and the stylized image.

In the technical solution provided in the embodiment, the mask image of the target region is provided for the received image to be processed, to provide the auxiliary information for the stylization processing process of the image to be processed, thereby distinguishing the target region from the non-target region. A trained stylization processing system with a stylization processing capability is preset, the image to be processed and the mask image are processed based on the stylization processing system, and the target region and the non-target region in the image to be processed are distinguished from each other based on the mask image, such that the stylized image associated with the target region is obtained. The stylized image takes both the image style and the consistency of content in the target region into consideration, and enhances the association between content in the target region in the stylized image and the original content in the target region, so that the stylized image maintains a high degree of identification of the content in the target region from the original content in the target region while having the image style changed, thereby giving a good presentation of the original content in the changed image style.

In one embodiment, the stylization processing system includes an encoding model, an image reconstruction model, and an image stylization model. The encoding model is used to encode an input image to obtain an image code corresponding to the input image, and the encoding model may be a neural network model. The image reconstruction model and the image stylization model may be neural network models, e.g. generator models. The image reconstruction model and the image stylization model each use input information as encoded data, and generate a corresponding image based on the encoded data, where the image reconstruction model is used to restore the encoded data to the image to be processed, and the image stylization model is used to generate the stylized image based on the encoded data. The encoding model is separately connected to the image reconstruction model and the image stylization model, and network layers in the image reconstruction model are connected to corresponding network layers in the image stylization model. Here, the connection between the corresponding network layers is used for implementing transmission of feature information from the network layers in the image reconstruction model to the network layers in the image stylization model. The image reconstruction model and the image stylization model each include a plurality of network layers, and there is a correspondence between the network layers in the image reconstruction model and the network layers in the image stylization model, where the network layers that have the correspondence therebetween may be some or all of the network layers in the models. For example, a correspondence is set between network layers at a same processing stage. In some embodiments, the image reconstruction model and the image stylization model include different network layers, for example, in terms of the number of network layers, or the type or structure of the plurality of network layers, etc. For example, a first network layer in the image reconstruction model may be connected to a first network layer in the image stylization model, and a second network layer in the image reconstruction model may be connected to a third network layer in the image stylization model, and so on. This is merely exemplary. The correspondence may be determined based on the structures of, and processing functions of the plurality of network layers in, the image reconstruction model and the image stylization model. In some embodiments, the image reconstruction model and the image stylization model have the same structure and the same network layers, and are trained separately by using different training data. Provision of the image reconstruction model and the image stylization model which have the same structure allows input information to be processed at the same stage by network layers with a corresponding layer number in the two models. The network layers with the same layer number are connected to each other for feature information transmission, so that pieces of feature information for fusion match each other. On the basis of simplifying the method for determining the correspondence between the network layers in the above two models, the degree of matching between pieces of feature information is improved, and the precision of the stylized image is improved. The network layers in the image reconstruction model are connected to the corresponding network layers in the image stylization model, that is, network layers with the same layer number are connected to each other. For each network layer in the image reconstruction model, feature information output from the network layer is transmitted to a corresponding network layer in the image stylization model, which then fuses feature information generated by itself with the feature information transmitted from the corresponding network layer in the image reconstruction model, to obtain characteristic information for outputting. The feature information output from the network layers in the image reconstruction model and the image stylization model may be a feature map or a feature matrix, which is not limited.

In some embodiments, the processing the image to be processed and the mask image based on a stylization processing system, to obtain a stylized image associated with the target region includes: inputting the image to be processed into the encoding model, to obtain an image code for the image to be processed; inputting the image code into the image reconstruction model, to obtain feature information for network layers in the image reconstruction model during processing of the image code by the image reconstruction model; and inputting the image code and the mask image into an input of the image stylization model, and inputting the feature information for the network layers in the image reconstruction model into the corresponding network layers in the image stylization model, respectively, to obtain the stylized image associated with the target region.

For example, with reference to FIG. 2, FIG. 2 is a schematic diagram of a structure of a stylization processing system according to an embodiment of the present disclosure. An image to be processed is input, as input information to an encoding model, into the encoding model, to obtain an image code corresponding to the image to be processed, where the image code may be in the form of a data matrix or a data vector, which is not limited. The image code is input, as input information to an image reconstruction model, into the image reconstruction model, where the image reconstruction model may include a plurality of network layers. One of the network layers generates feature information based on the input information, inputs the generated feature information into a next network layer, and, when the network layer in the image reconstruction model is connected to a network layer in an image stylization model, inputs the generated feature information into the corresponding network layer in the image stylization model.

The image code and a mask image are input, as input information, into the image stylization model from an input of the image stylization model, and feature information generated in the plurality of network layers in the image reconstruction model is used as input information to corresponding network layers in the image stylization model. A network layer in the image stylization model generates initial feature information for the current network layer based on the image code or target feature information output from a previous network layer, performs, based on the mask image, fusion processing on the initial feature information for the current network layer and feature information that is input from a corresponding network layer in the image reconstruction model, to obtain target feature information for the current network layer, and inputs the target feature information for the current network layer into a next network layer, until a last network layer in the image stylization model outputs the stylized image associated with the target region.

As an example, an image reconstruction model G1 and an image stylization model G2 have a same model structure and network layers in the image reconstruction model G1 and network layers with a corresponding layer number in the image stylization model G2 are connected to each other. In this example, feature information output from a plurality of network layers in the image reconstruction model G1 may be denoted as G1F={g1f₁, g1f₂, g1f₃, . . . , g1fₙ}, where n=the number of layers in G1, and g1f₁ is feature information output from a first network layer, and is correspondingly input into a first network layer in the image stylization model G2, and so on. Any network layer in the image stylization model generates initial feature information g2fᵢ for the current network layer based on the image code or target feature information output from a previous network layer, where i is the number of network layers. Based on a mask image, g1fᵢ and g2fᵢ are fused to obtain target feature information for the current network layer, and the target feature information for the current network layer is used as target feature information to be input into a next network layer. The feature information for each network layer may be in the form of a feature map. Correspondingly, a feature map output from a last network layer is the stylized image associated with the target region. Input information to the first network layer in the image stylization model is the image code, and input information to a non-first network layer is target feature information output from a previous network layer.

The network layer in the image stylization model may fuse the feature information g1fᵢ in the image reconstruction model with the initial feature information g2fᵢ for the current network layer by combining feature information corresponding to the target region and combining feature information corresponding to a non-target region with different weights, and then combining fused feature information based on the target region with fused feature information based on the non-target region, to obtain the target feature information. The fusion on the target region and on the non-target region with different weights may be implemented based on the mask image.

Optionally, the performing, based on the mask image, fusion processing on the initial feature information for the current network layer and feature information that is input from a corresponding network layer in the image reconstruction model, to obtain target feature information for the current network layer includes: performing, based on a first weight group, feature fusion on feature information inside the target region among the initial feature information and feature information inside the target region among the feature information that is input from the corresponding network layer in the image reconstruction model, to obtain a first fused feature; performing, based on a second weight group, feature fusion on feature information outside the target region among the initial feature information and feature information outside the target region among the feature information that is input from the corresponding network layer in the image reconstruction model, to obtain a second fused feature; and obtaining the target feature information for the current network layer based on the first fused feature and the second fused feature.

The first weight group includes a fusion weight for the feature information inside the target region among the initial feature information and a fusion weight for the feature information inside the target region among the feature information that is input from the corresponding network layer in the image reconstruction model. The second weight group includes a fusion weight for the feature information inside the non-target region, i.e., outside the target region, among the initial feature information and a fusion weight for the feature information inside the non-target region among the feature information that is input from the corresponding network layer in the image reconstruction model. For example, the first weight group includes a first weight of the initial feature information and a second weight of the feature information that is input from the corresponding network layer in the image reconstruction model, where both the first weight and the second weight are non-zero, and are values greater than 0 and less than 1, and a sum of the first weight and the second weight is 1. For example, the first weight is a, and the second weight is 1−a. The second weight group includes a third weight of the initial feature information and a fourth weight of the feature information that is input from the corresponding network layer in the image reconstruction model, where a sum of the third weight and the fourth weight is 1, the third weight is a value greater than 0 and less than or equal to 1, and the fourth weight is a value greater than or equal to 0 and less than 1. For example, the third weight is b, and the fourth weight is 1−b. The values of the weights in the first weight group and the second weight group may be set according to fusion requirements. The weight values are adjusted to implement control of the degree of consistency of content in the target region, such that stylized images achieving different degrees of consistency of content are obtained.

A fusion process of features in any network layer in the image stylization model may be implemented by the following formula: gfᵢ=a*g1fᵢ*mask+(1−a)*g2fᵢ*mask+b*g2fᵢ*(1−mask)+(1−b)*g1fᵢ*(1−mask), where gfᵢ is target feature information output from an i^{th} network layer in the image stylization model, g1fᵢ is feature information generated by the image reconstruction model at the i^{th} network layer, g2fᵢ is initial feature information generated in the i^{th} network layer in the image stylization model, and mask is a mask image. In this embodiment, a plurality of pixel positions in the target region in the mask image may be set to be 1, and a plurality of pixel positions in the non-target region therein may be set to be 0. Correspondingly, mask in the formula represents that the target region is 1, and a*g1fᵢ*mask+(1−a)*g2fᵢ*mask represents the fusion of feature information in the target region; and 1−mask represents that the non-target region is 1, and b*g2fᵢ*(1−mask)+(1−b)*g1fᵢ*(1−mask) represents the fusion on the non-target region. In some embodiments, a>1−b, that is, the weight in the target region that corresponds to the feature information generated by the image reconstruction model is increased as compared with that in the non-target region, so that the degree of stylization of the target region is reduced, and the similarity to the original content is thus increased.

In some embodiments, the non-target region directly uses the initial feature information without performing the fusion of feature information, so that the degree of stylization of the non-target region is increased. Correspondingly, the target feature information may be obtained by the following formula: gfᵢ=a*g1fᵢ*mask+(1−a)*g2fᵢ*mask+g2fᵢ*(1−mask).

Each network layer in the image stylization model performs the above processing process until the last network layer outputs the stylized image.

In the technical solution of this embodiment of the present disclosure, during restoration of the image code by the image reconstruction model, feature information are obtained for the plurality of network layers in the image reconstruction model, and the plurality of pieces of feature information are input into the corresponding network layers in the image stylization model; and during processing of the image code by the image stylization model, each network layer in the image stylization model performs, based on the mask image, fusion processing on the initial feature information generated by itself and feature information input by the image reconstruction model, to fuse feature information in the target region and fuse feature information in the non-target region with different weights, so that the degree of stylization of the target region is adjusted, and the stylized image associated with the target region is obtained. Therefore, the degree of stylization of a local region can be adjusted while stylization processing is performed on the image to be processed.

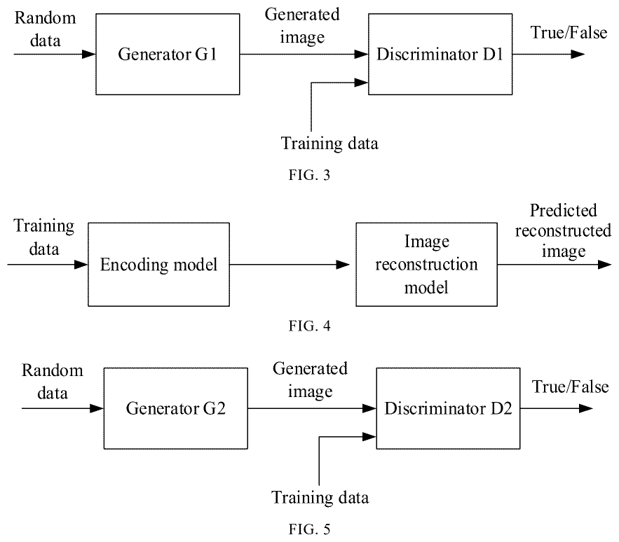

On the basis of the above embodiment, a training process of the image reconstruction model includes: training an image reconstruction model to be trained and a discrimination network model based on random data and a sample image, to obtain a trained image reconstruction model. In this embodiment, the image reconstruction model is a generator in a generative adversarial network, and the discrimination network model may be a discriminator in the generative adversarial network. The generative adversarial network is trained by using training data, and after the training of the generative adversarial network is completed, a trained image reconstruction model is obtained. For example, with reference to FIG. 3, FIG. 3 is a schematic diagram of a training process of an image reconstruction model according to an embodiment of the present disclosure. For example, a generative adversarial network includes a generator G1 and a discriminator D1, the generator G1 and the discriminator D1 are alternately trained until a training end condition is satisfied, and the trained generator G1 is then determined as an image generator. The alternate training process includes as follows. A network parameter of the generator G1 is fixed, random data is input into the generator G1 to obtain a reconstructed image output by the generator G1, the reconstructed image or training data being used as input information to the discriminator D1, and the discriminator D1 outputs a discrimination result for the input information and determines a loss function based on a tag of the input information, to adjust a network parameter of the discriminator D1. After preset training of the discriminator D1, the discriminator D1 is fixed and the generator G1 is trained, that is, the network parameter of the generator G1 is adjusted by using the determined loss function. The above training process is alternately performed until a condition such as reaching convergence is satisfied, and the trained generator G1 is then determined as the image reconstruction model.

In the above embodiment, the random data may be random noise. Optionally, a data format of the random data is set according to input requirements of the image reconstruction model. The data format may include data length, and the data length may be equal to the length of data output by the encoding model. Training data used for training the discriminator D1 may be acquired by an image acquisition device, for example, by capturing from a real object at different photographing angles and under different light intensities. The real object is not limited herein, and may be determined according to training requirements. In some embodiments, the real object may be a real person, etc. For example, the training data may alternatively be obtained by rendering a virtual character, or an image generated by a pre-trained generative adversarial network, etc., which is not limited.

On the basis of the above embodiment, a training process of the encoding model includes: iteratively performing the following training process until a training condition is satisfied, to obtain a trained encoding model: inputting a sample image into an encoding model to be trained, to obtain a training image code; inputting the training image code into a trained image reconstruction model, to obtain a reconstructed image; and adjusting a model parameter of the encoding model based on the sample image and the reconstructed image.

For example, with reference to FIG. 4, FIG. 4 is a schematic diagram of a training process of an encoding model according to an embodiment of the present disclosure. The encoding model is assisted in training based on a trained image reconstruction model. Training data is input into the encoding model to be trained, to obtain a training image code output by the encoding model, where the training data may be training data used for training an image reconstruction model, which is not limited herein. The training image code is input into the image reconstruction model, which then generates a reconstructed image based on the training image code, where the input training data is theoretical data of the reconstructed image. A loss function is determined based on the training data and the reconstructed image, and a network parameter of the encoding model is adjusted based on the loss function. The type of the loss function is not limited herein. A trained encoding model is determined by iteratively performing the above training process until a training end condition is satisfied.

On the basis of the above embodiment, a training method for the image stylization model includes: performing parameter initialization on the image stylization model based on a model parameter of the image reconstruction model; and training the initialized image stylization model to be trained and a discrimination network model based on random data and a stylized sample image, to obtain a trained image stylization model.

The image stylization model is a generator in a generative adversarial network, and the discrimination network model may be a discriminator in the generative adversarial network. The generative adversarial network is trained by using training data, and after the training of the generative adversarial network is completed, a trained image stylization model is obtained. Here, the training data used for training the image stylization model may be a stylized image. The stylized image may be read from an open-source commercially available dataset, or may be generated by an image processing software (Photoshop, PS) through image retouching, through rendering of a virtual character, or by the generative adversarial network, which is not limited herein.

In this embodiment, the image stylization model has the same structure as the image reconstruction model, in which a network parameter of the trained image stylization model is used as an initial network parameter of an image stylization model, that is, performing parameter initialization on the image stylization model, and the initialized image stylization model is iteratively trained, to obtain the trained image stylization model. In the initialization process, the network parameter of the image stylization model is assigned with a value, which facilitates accelerating the training of the image stylization model, shortening the training duration of the image stylization model, and also reducing the amount of training data required by the image stylization model in the training process, so as to reduce the difficulty in setting the training data.

For example, with reference to FIG. 5, FIG. 5 is a schematic diagram of a training process of an image stylization model according to an embodiment of the present disclosure. The training process of an image stylization model is similar to that of the image reconstruction model. An initialized generator and discriminator are alternately trained until a training end condition is satisfied. Details are not described herein again.

On the basis of the above embodiment, the method further includes: using the image to be processed and the stylized image as an image pair in training samples; and training an end-to-end mobile end network model based on a plurality of image pairs, to obtain an end-to-end stylization network model. Optionally, the end-to-end mobile end network model may include an encoder and a decoder. The encoder may down-sample an input image, and the decoder may up-sample a feature output from a previous network layer. The number of network layers in each of the encoder and the decoder is not limited herein.

Compared with the stylization processing system, the mobile end network model has a simpler structure, occupies less memory, and consumes less computing power in a running process, and thus adapts to be configured on a mobile end device such as a mobile phone, to implement stylization processing of an image on the mobile end device, so as to obtain the stylized image associated with the target region in the input image.

For example, the image to be processed and the stylized image, which is obtained by the stylization processing system by processing the image to be processed, are used as the image pair, where the image to be processed is used as input data to the mobile end network model, and the stylized image is used as standard data of predicted stylization data output by the mobile end network model, for generating a loss function with the predicted stylization data, to adjust a model parameter of the mobile end network model. The above training process is iteratively performed to obtain a mobile end network model having a stylization processing function.

In a plurality of image pairs described above as training data, a plurality of images to be processed have the same target region. Correspondingly, the trained mobile end network model can obtain a stylized image associated with the target region in the images to be processed. In some embodiments, the image to be processed is an image including a facial region, the target region is the facial region, and the stylized image is a stylized image associated with the facial region. Correspondingly, the mobile end network model trained based on the above image pairs can perform stylization processing on the input image to obtain the stylized image associated with the facial region in the input image.

In the technical solution provided in this embodiment, the mobile end network model is trained based on an input image processed by the stylization processing system and an output image, to obtain the mobile end network model adapted to mobile end applications, thereby implementing image stylization processing on a mobile end.

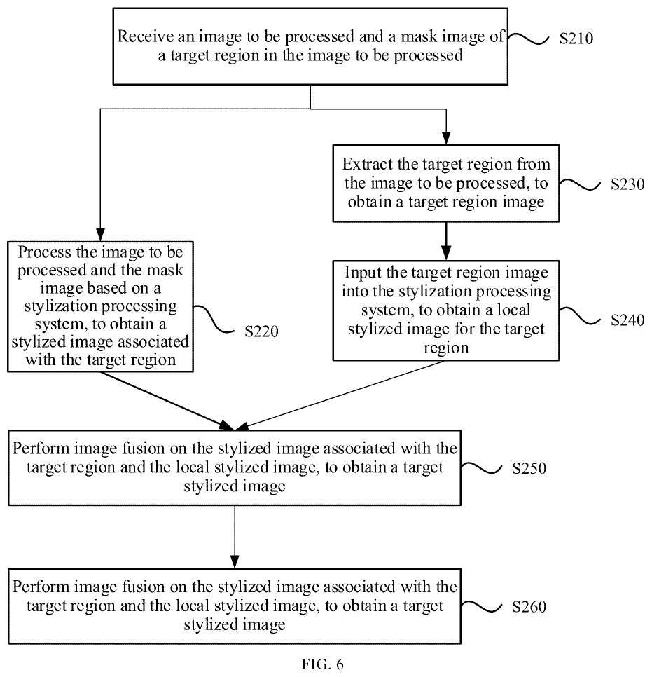

With reference to FIG. 6, FIG. 6 is a schematic flowchart of an image processing method according to an embodiment of the present disclosure. On the basis of the above embodiment, this embodiment is described. Optionally, the method further includes: extracting the target region from the image to be processed, to obtain a target region image; inputting the target region image into the stylization processing system, to obtain a local stylized image for the target region; and performing image fusion on the stylized image associated with the target region and the local stylized image, to obtain a target stylized image. Correspondingly, the displaying the stylized image associated with the target region includes: displaying the target stylized image. With reference to FIG. 6, the method includes the following steps.
S210: Receive an image to be processed and a mask image of a target region in the image to be processed.
S220: Process the image to be processed and the mask image based on a stylization processing system, to obtain a stylized image associated with the target region.
S230: Extract the target region from the image to be processed, to obtain a target region image.
S240: Input the target region image into the stylization processing system, to obtain a local stylized image for the target region.
S250: Perform image fusion on the stylized image associated with the target region and the local stylized image, to obtain a target stylized image.
S260: Display the target stylized image.

In this embodiment, the target region is obtained by performing segmentation on the image to be processed, to obtain the target region image, and the target region image is used as an input image to the stylization processing system for processing the target region image, to obtain a stylized target region image, i.e., the local stylized image for the target region. The mask image corresponding to the target region image may be a mask image in which pixel values are all 1.

Fusion of the stylized image obtained by performing overall processing on the image to be processed with the local stylized image obtained by performing local processing on the target region image to obtain the target stylized image allows for an increase in the consistency of content in the target region in the target stylized image and that in the target region in the image to be processed.

The fusion of the stylized image obtained by performing overall processing on the image to be processed with the local stylized image obtained by performing local processing on the target region image may be performing weighted processing on pixel points in the stylized image and corresponding pixel points in the local stylized image. Here, image weights for fusion are preset.

In the embodiment of the present disclosure, step S220, and steps S230 and S240 may be performed in sequence or in parallel, which is not limited herein.

In the technical solution provided in this embodiment, stylization processing is performed on a local image formed for the target region, to obtain the local stylized image. The local stylized image is not subject to the content in a non-target region, and is highly consistent with the content in the target region in the image to be processed. The local stylized image and the overall stylized image that corresponds to the image to be processed are fused to obtain the target stylized image, such that the consistency between content in the target region in the target stylized image and the original content is increased.

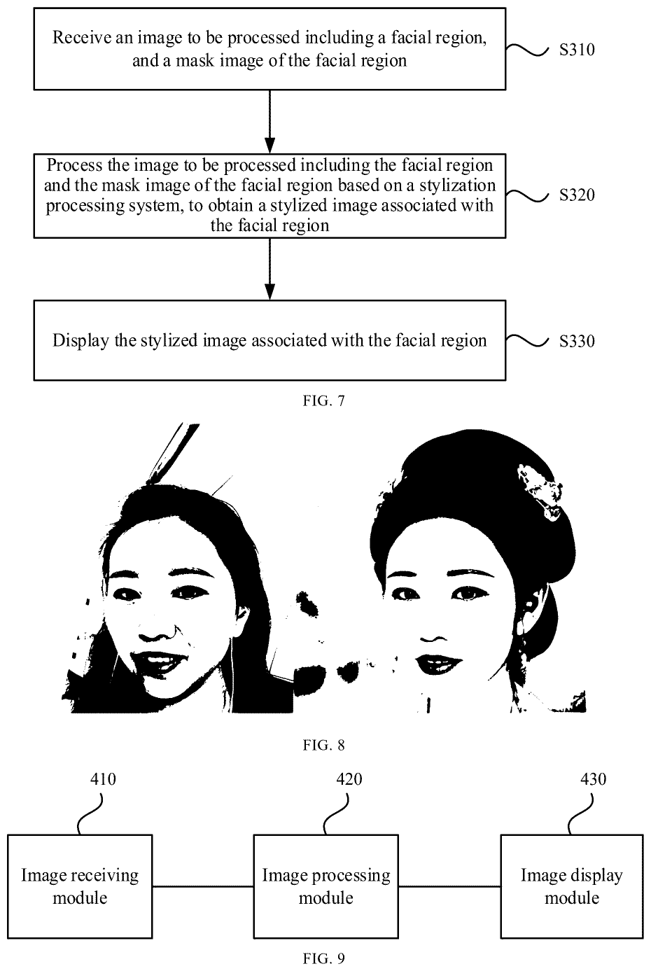

With reference to FIG. 7, FIG. 7 is a schematic flowchart of an image processing method according to an embodiment of the present disclosure. On the basis of the above embodiment, a processing process for an application scenario is provided. With reference to FIG. 7, the method includes the following steps.
S310: Receive an image to be processed including a facial region, and a mask image of the facial region.
S320: Process the image to be processed including the facial region and the mask image of the facial region based on the stylization processing system, to obtain a stylized image associated with the facial region.
S330: Display the stylized image associated with the facial region.

In this embodiment, the stylization processing system includes an encoding model, an image reconstruction model, and an image stylization model, where the encoding model, the image reconstruction model, and the image stylization model are obtained by using training data including portrait images and stylized portrait images. Correspondingly, the encoding model is a portrait encoding model, the image reconstruction model is a portrait reconstruction model, and the image stylization model is a portrait segmentation model.

When the image to be processed including a facial region is received, the facial region in the image to be processed is determined. For example, recognition may be performed on the image to be processed by a face recognition model (which may alternatively be a face segmentation model, for example), to obtain the facial region in the image to be processed, and the mask image of the facial region, i.e., a face mask.

The image to be processed is input into the encoding model, to obtain an image code; the image code is input into the image reconstruction model to obtain a set of feature information, i.e., G1F={g1f₁, g1f₂, g1f₃, . . . , g1fₙ}, output from a plurality of network layers in the image reconstruction model, where n=the number of layers in G1; the image code and the mask image are input into the image stylization model from an input; and the feature information output from the plurality of network layers in the image reconstruction model is input into corresponding network layers in the image stylization model, and region weighted fusion is performed on the feature information and initial feature information from the plurality of network layers by using the face mask, the fusion method being represented by g2fᵢ=a*g1fᵢ*mask+(1−a)*g2fᵢ*mask+g2fᵢ*(1−mask), until the stylized image is output. Weighted mixing is performed on the features of the facial region that are respectively obtained by the image reconstruction model and the image stylization model by using the face mask. A non-face includes features of hair and background regions. The use of the features obtained by the image stylization model may allow the degree of stylization of the facial region to be controllably adjusted, while maintaining stylized hair and background.

The facial region is extracted from the image to be processed, to form the facial region image, stylization processing is performed on the facial region image based on the stylization processing system, to obtain the local stylized image for the facial region, the facial region in the local stylized image and the facial region in the above stylized image obtained by performing overall processing on the image to be processed are fused through a facial fusion technique, to obtain a stylized image in which the facial region is more consistent with the real face.

For example, with reference to FIG. 8, FIG. 8 is a schematic diagram showing a comparison between an image to be processed and a stylized image according to an embodiment of the present disclosure. In FIG. 8, the left image is the image to be processed, and the right image is the stylized image obtained through processing of a stylization processing system. A portrait in each of the images is a virtual portrait composed by a device, and is merely an example. The image to be processed is a portrait image including a facial region. Correspondingly, the target region is the facial region. The stylization processing system changes the style of the image to an ancient style. It can be seen from FIG. 8 that regions other than the facial region, especially regions such as background and hair regions, in the image to be processed have a higher degree of stylization than the facial region, and are changed to the ancient style. After being changed to the ancient style, the facial region is highly similar to the original content, so that the similarity between the faces can be identified distinctly from the stylized image, thereby avoiding obvious inconsistency between the stylized image and the input image to be processed.

FIG. 9 is a schematic diagram of a structure of an image processing apparatus according to an embodiment of the present disclosure. As shown in FIG. 9, the apparatus includes: an image receiving module 410, an image processing module 420, and an image display module 430.

The image receiving module 410 is configured to receive an image to be processed and a mask image of a target region in the image to be processed.

The image processing module 420 is configured to process the image to be processed and the mask image based on a stylization processing system, to obtain a stylized image associated with the target region.

The image display module 430 is configured to display the stylized image associated with the target region.

In the technical solution provided in the embodiment of the present disclosure, the mask image of the target region is provided for the received image to be processed, to provide the auxiliary information for the stylization processing process of the image to be processed, thereby distinguishing the target region from the non-target region. A trained stylization processing system with a stylization processing capability is preset, the image to be processed and the mask image are processed based on the stylization processing system, and the target region and the non-target region in the image to be processed are distinguished from each other based on the mask image, such that the stylized image associated with the target region is obtained. The stylized image takes both the image style and the consistency of content in the target region into consideration.

On the basis of the above embodiment, optionally, the stylization processing system includes an encoding model, an image reconstruction model, and an image stylization model, where the encoding model is separately connected to the image reconstruction model and the image stylization model, and network layers in the image reconstruction model are connected to corresponding network layers in the image stylization model.

On the basis of the above embodiment, optionally, the image processing module 420 includes:
an image code determination module configured to input the image to be processed into the encoding model, to obtain an image code for the image to be processed;
a feature information determination module configured to input the image code into the image reconstruction model, to obtain feature information for network layers in the image reconstruction model during processing of the image code by the image reconstruction model; and
a stylized image determination module configured to input the image code and the mask image into an input of the image stylization model, and input the feature information for the network layers in the image reconstruction model into the corresponding network layers in the image stylization model, respectively, to obtain the stylized image associated with the target region.

On the basis of the above embodiment, optionally, a network layer in the image stylization model generates initial feature information for the current network layer based on feature information input from a previous network layer, performs, based on the mask image, fusion processing on the initial feature information for the current network layer and feature information that is input from a corresponding network layer in the image reconstruction model, to obtain target feature information for the current network layer, and inputs the target feature information for the current network layer into a next network layer, until a last network layer in the image stylization model outputs the stylized image associated with the target region.

On the basis of the above embodiment, optionally, the network layer in the image stylization model performs, based on a first weight group, feature fusion on feature information inside the target region among the initial feature information and feature information inside the target region among the feature information that is input from the corresponding network layer in the image reconstruction model, to obtain a first fused feature; the network layer in the image stylization model performs, based on a second weight group, feature fusion on feature information outside the target region among the initial feature information and feature information outside the target region among the feature information that is input from the corresponding network layer in the image reconstruction model, to obtain a second fused feature; and the network layer in the image stylization model obtains the target feature information for the current network layer based on the first fused feature and the second fused feature.

On the basis of the above embodiment, optionally, the apparatus further includes:
a facial region image extraction module configured to extract the target region from the image to be processed, to obtain a target region image;
a local stylized image generation module configured to input the target region image into the stylization processing system, to obtain a local stylized image for the target region; and
an image fusion module configured to perform image fusion on the stylized image associated with the target region and the local stylized image, to obtain a target stylized image.

The image display module 430 is configured to display the target stylized image.

On the basis of the above embodiment, optionally, the apparatus further includes:
an image reconstruction model training module configured to train an image reconstruction model to be trained and a discrimination network model based on random data and a sample image, to obtain a trained image reconstruction model.

On the basis of the above embodiment, optionally, the apparatus further includes:
an encoding model training module configured to iteratively perform the following training process until a training condition is satisfied, to obtain a trained encoding model: inputting a sample image into an encoding model to be trained, to obtain a training image code; inputting the training image code into a trained image reconstruction model, to obtain a reconstructed image; and adjusting a model parameter of the encoding model based on the sample image and the reconstructed image.

On the basis of the above embodiment, optionally, the apparatus further includes:
an image stylization model training module configured to: perform parameter initialization on the image stylization model based on a model parameter of the image reconstruction model; and train the initialized image stylization model to be trained and a discrimination network model based on random data and a stylized sample image, to obtain a trained image stylization model.

On the basis of the above embodiment, optionally, the image to be processed is an image including a facial region, and the target region is the facial region.

The image processing module 420 is configured to: process the image to be processed including the facial region and the mask image of the facial region based on the stylization processing system, to obtain a stylized image associated with the facial region.

On the basis of the above embodiment, optionally, the apparatus further includes:
a mobile end model training module configured to determine the image to be processed and the stylized image as an image pair in training samples, and train an end-to-end mobile end network model based on a plurality of image pairs, to obtain an end-to-end stylization network model.

The image processing apparatus provided in this embodiment of the present disclosure can perform the image processing method provided in any embodiment of the present disclosure, and has corresponding functional modules and effects for performing the method.

The plurality of units and modules included in the above apparatus are obtained through division merely according to functional logic, but are not limited to the above division, as long as corresponding functions can be implemented. In addition, the names of the plurality of functional units are merely used for mutual distinguishing, and are not intended to limit the protection scope of the embodiments of the present disclosure.

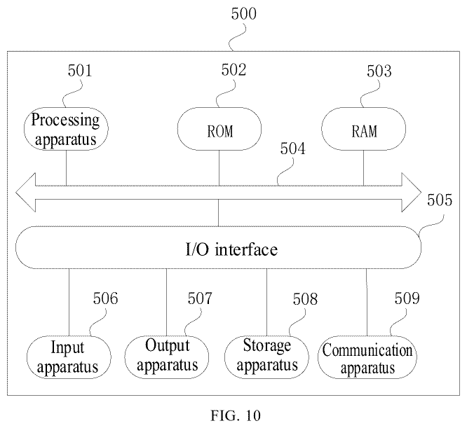

FIG. 10 is a schematic diagram of a structure of an electronic device according to an embodiment of the present disclosure. Reference is made to FIG. 10 below, which is a schematic diagram of a structure of an electronic device (such as a terminal device or a server in FIG. 10) 500 suitable for implementing an embodiment of the present disclosure. The terminal device in this embodiment of the present disclosure may include a mobile terminal such as a mobile phone, a notebook computer, a digital broadcast receiver, a personal digital assistant (PDA), a tablet computer (Portable Android Device, PAD), a portable media player (PMP), and a vehicle-mounted terminal (such as a vehicle navigation terminal), and a fixed terminal such as a digital television (TV) and a desktop computer. The electronic device shown in FIG. 10 is merely an example, and shall not impose any limitation on the function and scope of use of the embodiments of the present disclosure.

As shown in FIG. 10, the electronic device 500 may include a processing apparatus (e.g., a central processor, a graphics processor) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

The following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 10 shows the electronic device 500 having various apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the image processing methods provided in the above embodiments belong to the same concept. For the technical details not described in detail in this embodiment, reference can be made to the above embodiments, and this embodiment and the above embodiments have the same effects.

This embodiment of the present disclosure provides a computer storage medium having stored thereon a computer program that, when executed by a processor, causes the image processing methods provided in the above embodiments to be implemented.

The above computer-readable medium described in the present disclosure may be a computer-readable signal medium, or a computer-readable storage medium, or any combination thereof. The computer-readable storage medium may be, for example, electric, magnetic, optical, electromagnetic, infrared, or semiconductor systems, apparatuses, or devices, or any combination thereof. The computer-readable storage medium may include: an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including: electric wires, optical cables, radio frequency (RF), etc., or any suitable combination thereof.

In some implementations, a client and a server can communicate using any currently known or future-developed network protocol such as a HyperText Transfer Protocol (HTTP), and may be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to:
receive an image to be processed and a mask image of a target region in the image to be processed; process the image to be processed and the mask image based on a stylization processing system, to obtain a stylized image associated with the target region; and display the stylized image associated with the target region.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including LAN or WAN, or may be connected to an external computer (for example, connected over the Internet using an Internet service provider).

The flowcharts and block diagrams in the accompanying drawings illustrate the possibly implemented architecture, functions, and operations of the system, method, and computer program product according to multiple embodiments of the present disclosure. In this regard, each block in the flowchart or block diagram may represent a module, program segment, or part of code, and the module, program segment, or part of code contains one or more executable instructions for implementing the specified logical functions. In some alternative implementations, functions marked in the blocks may occur in a sequence different from that marked in the accompanying drawings. For example, two blocks shown in succession can actually be performed substantially in parallel, or they can sometimes be performed in the reverse order, depending on the functions involved. Each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under a circumstance.

The functions described herein above may be performed at least partially by one or more hardware logic components. For example, exemplary types of hardware logic components that may be used include: a field-programmable gate array (FPGA), an application-specific integrated circuit (ASIC), application-specific standard parts (ASSP), a system-on-chip (SOC) system, a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatus, or devices, or any suitable combination thereof. The machine-readable storage medium may include an electrical connection based on one or more wires, a portable computer disk, a hard disk, a RAM, a ROM, an EPROM, a flash memory, an optic fiber, a portable CD-ROM, an optical storage device, a magnetic storage device, or any suitable combination thereof. The storage medium may be a non-transitory storage medium.

According to one or more embodiments of the present disclosure, [Example 1] provides an image processing method. The method includes:
receiving an image to be processed and a mask image of a target region in the image to be processed; processing the image to be processed and the mask image based on a stylization processing system, to obtain a stylized image associated with the target region; and displaying the stylized image associated with the target region.

According to one or more embodiments of the present disclosure, [Example 2] provides an image processing method, the method further including:
the stylization processing system includes an encoding model, an image reconstruction model, and an image stylization model, where the encoding model is separately connected to the image reconstruction model and the image stylization model, and network layers in the image reconstruction model are connected to corresponding network layers in the image stylization model.

According to one or more embodiments of the present disclosure, [Example 3] provides an image processing method, the method further including:
the processing the image to be processed and the mask image based on a stylization processing system, to obtain a stylized image associated with the target region includes: inputting the image to be processed into the encoding model, to obtain an image code for the image to be processed; inputting the image code into the image reconstruction model, to obtain feature information for network layers in the image reconstruction model during processing of the image code by the image reconstruction model; and inputting the image code and the mask image into an input of the image stylization model, and inputting the feature information for the network layers in the image reconstruction model into the corresponding network layers in the image stylization model, respectively, to obtain the stylized image associated with the target region.

According to one or more embodiments of the present disclosure, [Example 4] provides an image processing method, the method further including:
a network layer in the image stylization model generates initial feature information for the current network layer based on the image code or target feature information output from a previous network layer, performs, based on the mask image, fusion processing on the initial feature information for the current network layer and feature information that is input from a corresponding network layer in the image reconstruction model, to obtain target feature information for the current network layer, and inputs the target feature information for the current network layer into a next network layer, until a last network layer in the image stylization model outputs the stylized image associated with the target region.

According to one or more embodiments of the present disclosure, [Example 5] provides an image processing method, the method further including: the network layer in the image stylization model performs, based on a first weight group, feature fusion on feature information inside the target region among the initial feature information and feature information inside the target region among the feature information that is input from the corresponding network layer in the image reconstruction model, to obtain a first fused feature; the network layer in the image stylization model performs, based on a second weight group, feature fusion on feature information outside the target region among the initial feature information and feature information outside the target region among the feature information that is input from the corresponding network layer in the image reconstruction model, to obtain a second fused feature; and the network layer in the image stylization model obtains the target feature information for the current network layer based on the first fused feature and the second fused feature.

According to one or more embodiments of the present disclosure, [Example 6] provides an image processing method, the method further including:
the method further includes: extracting the target region from the image to be processed, to obtain a target region image; inputting the target region image into the stylization processing system, to obtain a local stylized image for the target region; and performing image fusion on the stylized image associated with the target region and the local stylized image, to obtain a target stylized image; and
correspondingly, the displaying the stylized image associated with the target region includes: displaying the target stylized image.

According to one or more embodiments of the present disclosure, [Example 7] provides an image processing method, the method further including:
a training process of the image reconstruction model includes: training an image reconstruction model to be trained and a discrimination network model based on random data and a sample image, to obtain a trained image reconstruction model.

According to one or more embodiments of the present disclosure, [Example 8] provides an image processing method, the method further including:
a training process of the encoding model includes: iteratively performing the following training process until a training condition is satisfied, to obtain a trained encoding model: inputting a sample image into an encoding model to be trained, to obtain a training image code; inputting the training image code into a trained image reconstruction model, to obtain a reconstructed image; and adjusting a model parameter of the encoding model based on the sample image and the reconstructed image.

According to one or more embodiments of the present disclosure, [Example 9] provides an image processing method, the method further including: a training method for the image stylization model includes: performing parameter initialization on the image stylization model based on a model parameter of the image reconstruction model; and training the initialized image stylization model to be trained and a discrimination network model based on random data and a stylized sample image, to obtain a trained image stylization model.

According to one or more embodiments of the present disclosure, [Example 10] provides an image processing method, the method further including: the image to be processed is an image including a facial region, and the target region is the facial region; and
the processing the image to be processed and the mask image based on a stylization processing system, to obtain a stylized image associated with the target region includes: processing the image to be processed including the facial region and the mask image of the facial region based on the stylization processing system, to obtain a stylized image associated with the facial region.

According to one or more embodiments of the present disclosure, [Example 11] provides an image processing method, the method further including:
the method further includes: determining the image to be processed and the stylized image as an image pair in training samples, and training an end-to-end mobile end network model based on a plurality of image pairs, to obtain an end-to-end stylization network model.

According to one or more embodiments of the present disclosure, [Example 12] provides an image processing apparatus. The apparatus includes:
an image receiving module configured to receive an image to be processed and a mask image of a target region in the image to be processed;
an image processing module configured to process the image to be processed and the mask image based on a stylization processing system, to obtain a stylized image associated with the target region; and
an image display module configured to display the stylized image associated with the target region.

Furthermore, although the various operations are depicted in a specific order, it should not be construed as requiring these operations to be performed in the specific order shown or in a sequential order. Under certain circumstances, multitasking and parallel processing may be advantageous. Similarly, although a plurality of implementation details are included in the foregoing discussions, these details should not be construed as limiting the scope of the present disclosure. Some features that are described in the context of separate embodiments may alternatively be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, the subject matter defined in the appended claims is not necessarily limited to the specific features or actions described above. In contrast, the specific features and actions described above are merely exemplary forms of implementing the claims.

1. An image processing method, comprising:
receiving an image to be processed and a mask image of a target region in the image to be processed;
processing the image to be processed and the mask image based on a stylization processing system, to obtain a stylized image associated with the target region; and
displaying the stylized image associated with the target region.

2. The method according to claim 1, wherein the stylization processing system comprises an encoding model, an image reconstruction model, and an image stylization model, wherein the encoding model is separately connected to the image reconstruction model and the image stylization model, and network layers in the image reconstruction model are connected to corresponding network layers in the image stylization model.

3. The method according to claim 2, wherein the processing the image to be processed and the mask image based on a stylization processing system, to obtain a stylized image associated with the target region comprises:
inputting the image to be processed into the encoding model, to obtain an image code for the image to be processed;
inputting the image code into the image reconstruction model, to obtain feature information for network layers in the image reconstruction model during processing of the image code by the image reconstruction model; and
inputting the image code and the mask image into an input of the image stylization model, and inputting the feature information for the network layers in the image reconstruction model into the corresponding network layers in the image stylization model, respectively, to obtain the stylized image associated with the target region.

4. The method according to claim 3, wherein a network layer in the image stylization model generates initial feature information for the current network layer based on the image code or target feature information output from a previous network layer, performs, based on the mask image, fusion processing on the initial feature information for the current network layer and feature information that is input from a corresponding network layer in the image reconstruction model, to obtain target feature information for the current network layer, and inputs the target feature information for the current network layer into a next network layer, until a last network layer in the image stylization model outputs the stylized image associated with the target region.

5. The method according to claim 4, wherein the network layer in the image stylization model performs, based on a first weight group, feature fusion on feature information inside the target region among the initial feature information and feature information inside the target region among the feature information that is input from the corresponding network layer in the image reconstruction model, to obtain a first fused feature; the network layer in the image stylization model performs, based on a second weight group, feature fusion on feature information outside the target region among the initial feature information and feature information outside the target region among the feature information that is input from the corresponding network layer in the image reconstruction model, to obtain a second fused feature; and the network layer in the image stylization model obtains the target feature information for the current network layer based on the first fused feature and the second fused feature.

6. The method according to claim 1, wherein the method further comprises:
extracting the target region from the image to be processed, to obtain a target region image;
inputting the target region image into the stylization processing system, to obtain a local stylized image for the target region; and
performing image fusion on the stylized image associated with the target region and the local stylized image, to obtain a target stylized image; and
the displaying the stylized image associated with the target region comprises:
displaying the target stylized image.

7. The method according to claim 2, wherein a training process of the image reconstruction model comprises:
training an image reconstruction model to be trained and a discrimination network model based on random data and a sample image, to obtain a trained image reconstruction model.

8. The method according to claim 2, wherein a training process of the encoding model comprises:
iteratively performing the following training process until a training condition is satisfied, to obtain a trained encoding model:
inputting a sample image into an encoding model to be trained, to obtain a training image code;
inputting the training image code into a trained image reconstruction model, to obtain a reconstructed image; and
adjusting a model parameter of the encoding model based on the sample image and the reconstructed image.

9. The method according to claim 2, wherein a training method for the image stylization model comprises:
performing parameter initialization on the image stylization model based on a model parameter of the image reconstruction model; and
training the initialized image stylization model to be trained and a discrimination network model based on random data and a stylized sample image, to obtain a trained image stylization model.

10. The method according to claim 1, wherein the image to be processed is an image comprising a facial region, and the target region is the facial region; and
the processing the image to be processed and the mask image based on a stylization processing system, to obtain a stylized image associated with the target region comprises:
processing the image to be processed comprising the facial region and the mask image of the facial region based on the stylization processing system, to obtain a stylized image associated with the facial region.

11. The method according to claim 1, further comprising:
determining the image to be processed and the stylized image as an image pair in training samples, and training an end-to-end mobile end network model based on a plurality of image pairs, to obtain an end-to-end stylization network model.

12. (canceled)

13. An electronic device, comprising:
one or more processors; and
a storage apparatus configured to store one or more programs, wherein the one or more programs, when executed by the one or more processors, cause the one or more processors to:
receive an image to be processed and a mask image of a target region in the image to be processed;
process the image to be processed and the mask image based on a stylization processing system, to obtain a stylized image associated with the target region; and
display the stylized image associated with the target region.

14. A non-transitory storage medium comprising computer-executable instructions, wherein the computer-executable instructions, when executed by a computer processor, cause the computer processor to:
receive an image to be processed and a mask image of a target region in the image to be processed;
process the image to be processed and the mask image based on a stylization processing system, to obtain a stylized image associated with the target region; and
display the stylized image associated with the target region.

15. The electronic device according to claim 13, wherein the stylization processing system comprises an encoding model, an image reconstruction model, and an image stylization model, wherein the encoding model is separately connected to the image reconstruction model and the image stylization model, and network layers in the image reconstruction model are connected to corresponding network layers in the image stylization model.

16. The electronic device according to claim 15, wherein processing the image to be processed and the mask image based on a stylization processing system, to obtain a stylized image associated with the target region comprises:
inputting the image to be processed into the encoding model, to obtain an image code for the image to be processed;
inputting the image code into the image reconstruction model, to obtain feature information for network layers in the image reconstruction model during processing of the image code by the image reconstruction model; and
inputting the image code and the mask image into an input of the image stylization model, and inputting the feature information for the network layers in the image reconstruction model into the corresponding network layers in the image stylization model, respectively, to obtain the stylized image associated with the target region.

17. The electronic device according to claim 16, wherein a network layer in the image stylization model generates initial feature information for the current network layer based on the image code or target feature information output from a previous network layer, performs, based on the mask image, fusion processing on the initial feature information for the current network layer and feature information that is input from a corresponding network layer in the image reconstruction model, to obtain target feature information for the current network layer, and inputs the target feature information for the current network layer into a next network layer, until a last network layer in the image stylization model outputs the stylized image associated with the target region.

18. The electronic device according to claim 17, wherein the network layer in the image stylization model performs, based on a first weight group, feature fusion on feature information inside the target region among the initial feature information and feature information inside the target region among the feature information that is input from the corresponding network layer in the image reconstruction model, to obtain a first fused feature; the network layer in the image stylization model performs, based on a second weight group, feature fusion on feature information outside the target region among the initial feature information and feature information outside the target region among the feature information that is input from the corresponding network layer in the image reconstruction model, to obtain a second fused feature; and the network layer in the image stylization model obtains the target feature information for the current network layer based on the first fused feature and the second fused feature.

19. The electronic device according to claim 13, wherein the electronic device is further caused to:
extract the target region from the image to be processed, to obtain a target region image;
input the target region image into the stylization processing system, to obtain a local stylized image for the target region; and
perform image fusion on the stylized image associated with the target region and the local stylized image, to obtain a target stylized image; and
wherein displaying the stylized image associated with the target region comprises: displaying the target stylized image.

20. The electronic device according to claim 15, wherein a training process of the image reconstruction model comprises:
training an image reconstruction model to be trained and a discrimination network model based on random data and a sample image, to obtain a trained image reconstruction model.

21. The electronic device according to claim 15, wherein a training process of the encoding model comprises:
iteratively perform the following training process until a training condition is satisfied, to obtain a trained encoding model:
input a sample image into an encoding model to be trained, to obtain a training image code;
input the training image code into a trained image reconstruction model, to obtain a reconstructed image; and
adjust a model parameter of the encoding model based on the sample image and the reconstructed image.
